(19) United States
(12) Patent Application Publication
(10) Pub. No.: US 2004/0103813 A1
(43) Pub. Date: Jun. 3, 2004

(54) Paste for electroless plating and method of producing metallic structured body, micrometallic component, and conductor circuit using the paste

(75) Inventors: Jun Yorita, Osaka (JP); Masatoshi Majima, Osaka (JP); Shinji Inazawa, Osaka (JP)

Correspondence Address: McDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/703,533

(22) Filed: Nov. 10, 2003

(30) Foreign Application Priority Data
Nov. 11, 2002 (JP) 327217/2002

(51) Int. Cl. C09D 5/00

(52) U.S. Cl. 106/1.12; 427/96; 427/98

(57) ABSTRACT

A paste for electroless plating 1′ comprises (a) a minute catalytic powder 11 at least the surface of which is formed by a catalytic metal or a metal capable of substituting for the catalytic metal and (b) a vehicle 10 in which the catalytic powder 11 is dispersed. The paste is used to form a film. A method that plates the film by electroless plating produces a metallic structured body, a micrometallic component, and a conductor circuit, all having a uniform crystal structure unattainable by electroplating using a conductive paste.

### BACKGROUND OF THE INVENTION

1. Field of the Invention

The present invention relates to an innovative paste for electroless plating and a method of producing a metallic structured body, a micrometallic component, and a conductor circuit, the method incorporating the use of electroless plating using the paste.

2. Description of the Background Art

The published Japanese patent application Tokukaihei 9-31684 has disclosed a technique for growing a metallic film by the following method. First, a conductive paste is produced by dispersing a minute metallic powder acting as the conductive component into a solvent together with a vehicle made of, for example, a synthetic resin. The conductive paste is used to form a conductive film having an intended shape. The conductive film is used as the electrode for growing the metallic film by electroplating.

Researchers and engineers have been studying a method for producing the above-described metallic structured body and micrometallic component and other metallic products by applying the foregoing technique.

For example, it is conceivable to produce by the following process a metallic structured body having a complex, minute three-dimensional structure, such as a metallic porous body suitable for use as the electrode in a battery, for example. First, a porous body made of polyurethane foam or another synthetic resin is prepared as a precursor. The porous body is coated with a conductive paste to form a conductive film. The conductive film is used as the electrode for the electroplating to form a metallic film. Subsequently, as required, a heat treatment is performed to burn out and remove the synthetic resin and other needless materials in the precursor and conductive film.

Furthermore, it is conceivable to produce by the following process using the above-described conductive paste a micrometallic component having a thickness slightly over 100 μm and a minute three-dimensional structure with an accuracy of the submicron order, which is used as a functional part for a semiconductor chip such as an LSI or as a component for a micromachine.

First, a conductive paste is applied onto the surface of a conductive material such as a metal plate. An insulating mold form having a patterned through hole according to the shape of the micrometallic component is produced by using a material such as a synthetic resin. The mold form is overlaid on the conductive paste. Then, the conductive paste is solidified to form the conductive film and to produce a mold by securely bonding the mold form to the substrate at the same time.

Next, a metallic film corresponding with the shape of the patterned through hole is selectively grown on the surface of the conductive film exposed in the patterned through hole on the mold by electroplating with the conductive film used as the electrode. The production of the micrometallic component is completed by removing the substrate, mold form, and conductive film constituting the mold.

Another conceivable method for producing a micrometallic component is as follows. First, the pattern of a conductive paste is formed on the surface of an insulating substrate by printing to form a conductive film corresponding with the shape of the micrometallic component. Next, a metallic film corresponding with the shape of the conductive film is selectively grown on the surface of the conductive film on the substrate by electroplating with the conductive film used as the electrode. Finally, the substrate and conductive film are removed.

However, the metallic powder contained as the conductive component in the conventional conductive paste has an average particle diameter of 1 μm or more. In other words, the metallic particle is not sufficiently small in comparison with the minute three-dimensional structure and other members included in the metallic structured body and micrometallic component. Consequently, when the surface of the conductive film formed by using the conventional conductive paste is observed microscopically at the level of these minute structures, the conductive portions in which metallic particles are exposed and the insulating portions sandwiched between the conductive portions are dispersed by forming an irregularly spotted distribution in accordance with the size of the metallic particle. This condition is electrically nonuniform. In addition, the surface of the formed conductive film has an unevenness not sufficiently small in comparison with the minute three- and two-dimensional structures. The unevenness corresponds with the size of the metallic particle. In short, the surface is not flat.

The crystal structure of a metallic film produced by electroplating tends to be affected by the underlying film. When the metallic film is grown on a conductive film having an electrically nonuniform and geometrically uneven surface as described above, the grain size of the crystal growing at the early stage of growth, in particular, tends to be significantly larger than the intrinsic grain size of the crystal growing on an even metallic surface, for example. As the metallic film grows, its surface becomes similar to the even metallic surface. At this stage, the crystal grain becomes to have a size similar to the intrinsic size of the crystal grain growing on an even metallic surface. After this stage, the metallic film grows with this grain size.

As a result, the metallic film grown on a conductive layer by electroplating cannot have a uniform crystal structure throughout its thickness. In other words, the grain size of the crystal of the metal has a thicknesswise distribution that varies discontinuously. More specifically, the metallic film has a dual-layer structure: one layer having a larger grain size of the crystal of the metal than the intrinsic grain size and the overlying other layer having the intrinsic grain size.

In the underlying region having a larger grain size of the crystal of the metal than the intrinsic grain size, an intended physical, mechanical, or electrical property cannot be achieved. This drawback poses a problem in that the metallic film cannot have an intended physical, mechanical, or electrical property as its entirety.

Moreover, because the metallic film includes a region having a different physical or mechanical property as explained above, changes in outside conditions such as temperature variations may produce strain or, in the worst case, may fracture the metallic film.

### SUMMARY OF THE INVENTION

An object of the present invention is to offer an innovative paste for electroless plating that can form a metallic film having a uniform crystal structure unattainable by electroplating using a conductive paste. The paste for electroless plating can form a metallic film having an intended minute structure by electroless plating. Another object of the present invention is to offer a method of producing a metallic structured body, a micrometallic component, and a conductor circuit by using the paste for electroless plating.

According to the present invention, the foregoing object is attained by offering the following paste for electroless plating. The paste comprises:

(a) a minute catalytic powder at least the surface of which is formed by:

(a1) a catalytic metal having a catalytic function as an underlying material for electroless plating (hereinafter referred to as the catalytic metal (1)); or

(a2) a metal capable of substituting for the catalytic metal (1) when brought into contact with a solution containing the ion of the catalytic metal (1) (hereinafter referred to as the metal (2)); and

(b) a vehicle in which the catalytic powder is dispersed.

This structure enables the growth of a metallic film by electroless plating through the following process. First, the paste for electroless plating is used to form an underlying film. When the underlying film is brought into contact with an electroless-plating liquid, the catalytic powder exposed on the surface of the underlying film exercises its catalytic function to form the metallic film on the surface of the underlying film. Unlike the metallic film formed by electroplating, the grown metallic film has the intrinsic grain size of the metallic crystal even at the early stage of the growth without being affected by the underlying film. As a result, the metallic film can have a uniform crystal structure with the intrinsic grain size of the metal throughout its thickness. Consequently, the metallic film can have the intended physical, mechanical, and electrical properties the metal inherently has.

Furthermore, the paste for electroless plating can be used with a manner similar to one for the conventional conductive paste for electroplating. More specifically, when the paste for electroless plating is applied onto an underlying material having a three-dimensional structure, an underlying film can be formed with an intended three-dimensional structure. When the pattern of an underlying film is formed by a method such as printing, the underlying film having an intended two-dimensional structure can be formed. Consequently, when a metallic film is grown by electroless plating on the underlying film formed by the foregoing method, the metallic film can have an intended minute three- or two-dimensional structure.

As described above, the structure of the paste for electroless plating of the present invention enables the formation of a metallic film having a uniform crystal structure unattainable by electroplating using a conductive paste. The paste for electroless plating can form a metallic film having an intended minute structure by electroless plating.

According to one aspect of the present invention, the present invention offers the following method of producing a metallic structured body. The method comprises the following steps:

(a) preparing the paste for electroless plating of the present invention;

(b) preparing a precursor of the metallic structured body, the precursor having a three-dimensional structure;

(c) applying the paste onto the surface of the precursor to form an underlying film; and

(d) growing a metallic film on the surface of the underlying film through electroless plating by exploiting the catalytic function of the catalytic powder exposed on the surface of the underlying film.

This structure can exploit the effect of the electroless plating that utilizes the catalytic function of the above-described catalytic metal. As a result, a metallic film having a uniform crystal structure can be formed on the surface of the precursor. The metallic film has the intrinsic grain size of the crystal of the metal throughout its thickness. Consequently, the metallic structured body can have the intended good physical, mechanical, and electrical properties the metal inherently has.

According to another aspect of the present invention, the present invention offers a method of producing a micrometallic component. The method comprises the following steps:

(a) preparing a paste for electroless plating of the present invention;

(b) preparing a substrate;

(c) preparing a mold form provided with a patterned through hole corresponding with the shape of the micrometallic component to be produced;

(d) applying the paste onto the substrate;

(e) overlaying the mold form on the applied paste;

(f) solidifying the paste while maintaining the overlaying condition to form an underlying film and to securely bond the mold form to the substrate at the same time so that a mold can be produced; and

(g) selectively growing a metallic film corresponding with the shape of the patterned through hole on the surface of the underlying film exposed in the patterned through hole of the mold by electroless plating utilizing the catalytic function of the catalytic powder exposed on the surface of the underlying film.

This structure can exploit the effect of the electroless plating that utilizes the catalytic function of the above-described catalytic metal. As a result, a metallic film having a uniform crystal structure similar to the foregoing one can be formed selectively on the surface of the underlying film exposed in the patterned through hole of the mold. Consequently, a micrometallic component having good properties can be produced.

According to yet another aspect of the present invention, the present invention offers another method of producing a micrometallic component. The method comprises the following steps:

(a) preparing a paste for electroless plating of the present invention;

(b) preparing a substrate;

(c) on the substrate, forming by using the paste the pattern of an underlying film corresponding with the shape of the micrometallic component to be produced; and

(d) selectively growing a metallic film corresponding with the shape of the underlying film on the surface of the underlying film on the substrate by electroless plating utilizing the catalytic function of the catalytic powder exposed on the surface of the underlying film.

This structure can exploit the effect of the electroless plating that utilizes the catalytic function of the above-described catalytic metal. As a result, a metallic film having a uniform crystal structure similar to the foregoing one can be formed selectively on the surface of the pattern of the underlying film formed on the substrate. Consequently, a micrometallic component having good properties can be produced.

According to yet another aspect of the present invention, the present invention offers a method of producing a conductor circuit. The method comprises the following steps:

(a) preparing a paste for electroless plating of the present invention;

(b) preparing a substrate;

(c) on the substrate, forming by using the paste the pattern of an underlying film corresponding with the shape of the conductor circuit to be produced; and

(d) selectively growing a metallic film corresponding with the shape of the underlying film on the surface of the underlying film on the substrate by electroless plating utilizing the catalytic function of the catalytic powder exposed on the surface of the underlying film.

This structure can exploit the effect of the electroless plating that utilizes the catalytic function of the above-described catalytic metal. As a result, a metallic film having a uniform crystal structure similar to the foregoing one can be formed selectively on the surface of the pattern of the underlying film formed on the substrate. Consequently, a conductor circuit having good properties can be produced.

### BRIEF DESCRIPTION OF THE DRAWING

In the drawing:

FIGS. 1(a) to 1(f) are diagrams explaining the types of chain-shaped metallic powders to be used as the nucleus of the catalytic powder for the paste for electroless plating of the present invention.

FIGS. 2(a) to 2(c) are enlarged diagrams showing the surface portion of the underlying film formed by using a paste including a catalytic powder incorporating a chain-shaped metallic powder as the nucleus to explain the process of growing a metallic film on the surface of the underlying film by electroless plating.

FIGS. 3(a) to 3(d) are diagrams explaining an example of the process for forming the mold form to be used in the method of the present invention to produce a micrometallic component.

FIGS. 4(a) and 4(b) are diagrams explaining an example of the process for forming a mold by using the foregoing mold form.

FIGS. 5(a) to 5(c) are diagrams explaining another example of the process for forming the mold.

FIGS. 6(a) to 6(d) are diagrams explaining an example of the process for producing a micrometallic component by a method of the present invention using the foregoing mold.

FIGS. 7(a) to 7(c) are diagrams explaining an example of the process for producing the micrometallic component by another method of the present invention.

FIGS. 8(a) and 8(b) are diagrams explaining an example of the process for producing a conductor circuit by using the paste for electroless plating of the present invention.

### DETAILED DESCRIPTION OF THE INVENTION

<Paste for Electroless Plating>

The present invention offers the following paste for electroless plating. The paste comprises:

(a) a minute catalytic powder at least the surface of which is formed by:

(a1) a catalytic metal having a catalytic function as an underlying material for electroless plating (hereinafter referred to as the catalytic metal (1)); or

(a2) a metal capable of substituting for the catalytic metal (1) when brought into contact with a solution containing the ion of the catalytic metal (1) (hereinafter referred to as the metal (2)); and

(b) a vehicle in which the catalytic powder is dispersed.

It is desirable that the catalytic metal (1) be at least one element selected from the group consisting of Pd, Ag, Au, and Pt. These catalytic metals (1) have an excellent catalytic function as an underlying film for the electroless plating. Consequently, a considerably uniform and dense metallic film can be formed on the underlying film.

It is desirable that the metal (2) be at least one element selected from the group consisting of Sn and Zn. When brought into contact with a solution containing the ion of the catalytic metal (1), Sn and Zn are substituted by the catalytic metals quickly and efficiently. As a result, a catalytic function can be given highly efficiently to the surface of the underlying film. In addition, Sn and Zn are less costly than the catalytic metal (1). Therefore, it is possible to reduce the cost of the paste for electroless plating and consequently the production cost of the metallic structured body and the micrometallic component produced by using the paste, because the amount of costly catalytic metals can be reduced to the required minimum.

It is also desirable that the catalytic powder have a nucleus made of metal, synthetic resin, or ceramic and that the nucleus be coated with the catalytic metal (1) or the metal (2). When this structure is employed, it is possible to considerably reduce the cost of the paste for electroless plating and consequently the production cost of the metallic structured body and the micrometallic component produced by using the paste for electroless plating in comparison with the structure in which the entire catalytic powder is formed by the catalytic metal (1), because the amount of the costly catalytic metal (1) can also be decreased to the required minimum.

It is more desirable that the nucleus of a catalytic powder be made of a metallic powder having a structure in which a multitude of minute metallic particles are linked so as to form a chain. The chain-shaped catalytic powder having the chain-shaped metallic powder as its nucleus has a dispersibility in the vehicle superior to a catalytic powder having another shape such as a granular shape. Consequently, the chain-shaped catalytic powder can be more uniformly dispersed on the entire surface of the underlying film. As a result, a metallic film can be grown uniformly and nearly simultaneously on the entire surface of the underlying film by electroless plating, so that the metallic film is formed with a uniform thickness and a uniform crystal structure.

The chain-shaped catalytic powder has a chain length-to-chain diameter ratio as large as 10 to 100 or so, and its chain sometimes has branches to a moderate degree. This structure facilitates the formation of a good conductive network in the underlying film by connecting the chains to one another. As a result, the conductivity of the underlying film can be increased. As described below, for example, when the metallic film formed on the underlying film is further grown by electroplating with the metallic film used as the electrode, the underlying film can be used as a portion for feeding a current to the metallic film used as the electrode.

It is also desirable to add as a conductive component a metallic powder having a structure in which a multitude of minute metallic particles are linked so as to form a chain. As with the above-described case, the chain-shaped metallic powder added as the conductive component has a chain length-to-chain diameter ratio as large as 10 to 100 or so, and its chain sometimes has branches to a moderate degree. This structure facilitates the formation of a good conductive network in the underlying film by connecting the chains to one another. As a result, the conductivity of the underlying film can also be increased. As with the above-described case, the underlying film can be used as a portion for feeding a current to the metallic film used as the electrode. In this case, the catalytic powder may take any shape such as a chain shape or a granular shape.

(Chain-Shaped Metallic Powder)

The chain-shaped metallic powder either to be used as the nucleus of the catalytic powder or to be added as the conductive component can be produced by various methods such as the vapor-phase method and the liquid-phase method providing that the powder has a chain-shaped structure.

It is desirable that the chain-shaped metallic powder be formed by metallic particles having a diameter of the submicron order, more desirably at most 400 nm. It is desirable that the chain have a diameter of at most 1 μm. When the chain-shaped metallic powder to be used as the nucleus of the catalytic powder is formed by the metallic particles having a diameter as specified above, and the chain has a diameter as specified above, the dispersibility of the catalytic powder in the vehicle can be improved. Consequently, the catalytic powder can be more uniformly dispersed on the surface of the underlying film. As a result, the metallic film can be grown more uniformly and nearly simultaneously on the entire surface of the underlying film by electroless plating, so that the metallic film is formed with a more uniform thickness and a more uniform crystal structure.

Furthermore, the catalytic powder can form a good conductive network in the underlying film. The network can give a good conductivity to the underlying film so that the underlying film can be used as the current-feeding portion at the time of electroplating.

When the chain-shaped metallic powder is used as a conductive component, the metallic powder formed by the metallic particles having the above-specified diameter and the chain having the above-specified diameter can also have an improved dispersibility in the vehicle. As a result, the metallic powder can form a good conductive network in the underlying film, giving it a good conductivity.

It is more desirable to reduce the above-specified upper limit of the diameter of the metallic particles to at most 200 nm to further increase the dispersibility of the catalytic powder in the vehicle. However, if the particle diameter is excessively small, the size of the metallic powder linked in the shape of a chain becomes excessively small. As a result, the metallic powder may not sufficiently obtain the above-described effect of forming a good conductive network in the underlying film. Therefore, it is desirable that the metallic particles have a diameter of at least 10 nm.

In addition, it is more desirable to reduce the above-specified upper limit of the diameter of the chain to at most 400 nm to further increase the dispersibility of the catalytic powder in the vehicle. However, if the chain diameter is excessively small, the applied stress during the production or application of the paste for electroless plating may readily break the chain. Therefore, it is desirable that the chain have a diameter of at least 10 nm.

For forming the above-described chain-shaped metallic powder, it is desirable that the metallic powder or the individual metallic particles forming the metallic powder be formed by one of the following materials:

(i) a single paramagnetic metal;

(ii) an alloy comprising at least two types of paramagnetic metals;

(iii) an alloy comprising at least one paramagnetic metal and at least one other metal; and

(iv) a composite including a paramagnetic metal.

When minute metallic particles having a diameter of the submicron order and including a paramagnetic metal are deposited by a method such as the below-described reductive deposition method, the metallic particles are formed with a single-crystalline structure or a similar structure. Consequently, they are simply polarized to form a dipole. The dipole structure promotes the linking of a multitude of metallic particles to form a chain. As a result, the chain-shaped metallic powder is formed spontaneously. This process facilitates the production of the chain-shaped metallic powder, enabling the production-efficiency improvement and cost reduction of the paste for electroless plating.

As described below, the types of the above-described metallic powder include various metallic powders having various structures. For example, a metallic powder has a structure in which a multitude of minute metallic particles are linked simply by magnetic force so as to form a chain. Another metallic powder has a structure in which a metallic layer is further deposited around the linked metallic particles to strongly bond the metallic particles. In any of these types, the metallic particles basically retain the magnetic force. Therefore, the chains cannot be readily broken by the applied stress during the production or application of the paste for electroless plating. Even if they are broken, they can readily recombine when the applied stress disappears. Furthermore, in the applied coating, a plurality of catalytic powders or metallic powders readily come into contact with one another due to the magnetic force of the metallic particles. This contact facilitates the formation of a conductive network. As a result, a further increased conductivity can be given to the underlying film.

The concrete examples of the metallic powder including a paramagnetic metal include any one type of or a mixture of at least two types of the following metallic powders:

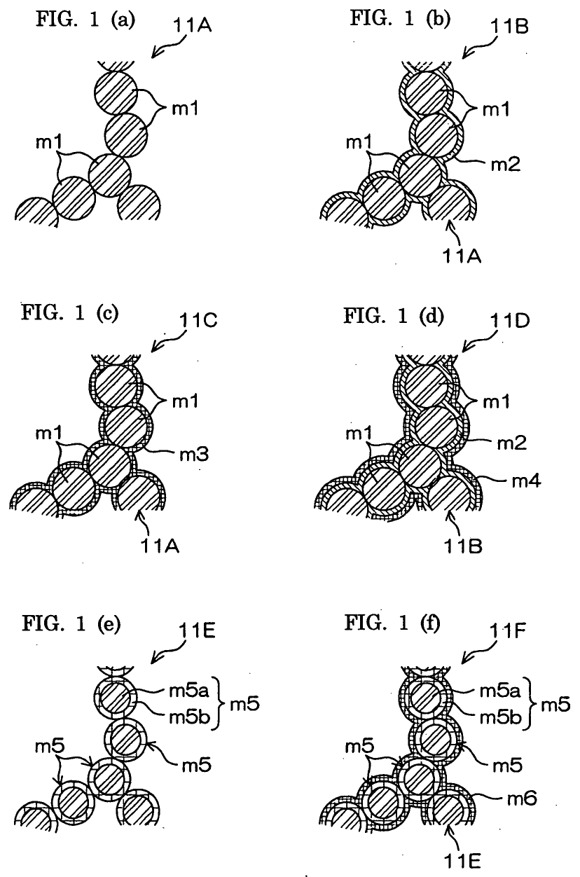

(a) A metallic powder 11A whose one part is enlarged and shown in FIG. 1(a). In this powder, metallic particles m1 are formed by one of the following materials:

(a1) a single paramagnetic metal;

(a2) an alloy comprising at least two types of paramagnetic metals; and

(a3) an alloy comprising at least one paramagnetic metal and at least one other metal.

A multitude of metallic particles m1 having a diameter of the submicron order are linked by their own magnetic property to form a chain.

(b) A metallic powder 11B whose one part is enlarged and shown in FIG. 1(b). In this powder, a metallic layer m2 is deposited on the surface of the metallic powder 11A described in (a) above to strongly bond the metallic particles. The metallic layer m2 is made of one of the following materials:

(b1) a single paramagnetic metal;

(b2) an alloy comprising at least two types of paramagnetic metals; and

(b3) an alloy comprising at least one paramagnetic metal and at least one other metal.

(c) A metallic powder 11C whose one part is enlarged and shown in FIG. 1(c). In this powder, a metallic layer m3 is deposited on the surface of the metallic powder 11A described in (a) above to strongly bond the metallic particles. The metallic layer m3 is made of a metal or alloy other than those used in the metallic powder 11A and the metallic layer m2.

(d) A metallic powder 11D whose one part is enlarged and shown in FIG. 1(d). In this powder, a metallic layer m4 is deposited on the surface of the metallic powder 11B described in (b) above to strongly bond the metallic particles. The metallic layer m4 is made of a metal or alloy other than those used in the metallic layer m2.

(e) A metallic powder 11E whose one part is enlarged and shown in FIG. 1(e). In this powder, cores m5a are formed by one of the following materials:

(e1) a single paramagnetic metal;

(e2) an alloy comprising at least two types of paramagnetic metals; and

(e3) an alloy comprising at least one paramagnetic metal and at least one other metal.

The surfaces of the cores m5a are coated with coatings m5b to obtain composites m5, which act as metallic particles. The coatings m5b are made of a metal or alloy other than those used in the cores m5a. A multitude of metallic particles expressed as the composites m5 are linked by the magnetic property of the cores m5a to form a chain.

(f) A metallic powder 11F whose one part is enlarged and shown in FIG. 1(f). In this powder, a metallic layer m6 is deposited on the surface of the metallic powder 11E described in (e) above to strongly bond the metallic particles. The metallic layer m6 is made of a metal or alloy other than those used in the metallic layer m5b.

In FIGS. 1(a) to 1(f), the metallic layers m2, m3, m4, and m6 and the coatings m5b are illustrated as a single layer. However, they may have a laminated structure in which at least two layers made of the same or different metallic materials are laminated. In the above description, it is desirable to deposit the following members by the earlier-mentioned reductive deposition method:

(i) the metallic powder or the entire metallic particles formed by one of the following materials:

(i-i) a single paramagnetic metal;

(i-ii) an alloy comprising at least two types of paramagnetic metals; and

(i-iii) an alloy comprising at least one paramagnetic metal and at least one other metal; and

(ii) the paramagnetic-metal-including portion included in the metallic powder or metallic particles formed by a composite including a paramagnetic metal.

In this case, the reductive deposition method is performed by adding a reducing agent to a solution containing the ion of the paramagnetic metal constituting the foregoing members. Thus, the foregoing members are deposited in the liquid to complete the formation.

It is desirable to use a trivalent titanium ion (Ti³⁺) as the reducing agent in the reductive deposition method. When the trivalent titanium ion is used as the reducing agent, after the formation of the metallic powder, the aqueous solution containing the oxidized tetravalent titanium ion can be electrolytically reconditioned to reduce the titanium ion to the original trivalence. This process can be repeated to recondition the aqueous solution so as to be used for the production of the metallic powder.

In the reductive deposition method using a trivalent titanium ion as the reducing agent, it is desirable to produce the metallic powder by the following process. First, a reductant solution is prepared by the electrolysis of an aqueous solution of a tetravalent titanium compound, such as titanium tetrachloride, to reduce part of the tetravalent titanium ion to a trivalence. Next, the reductant solution is mixed with an aqueous solution (reaction liquid) containing the ion of the metal for forming the metallic powder. When the trivalent titanium ion is oxidized to a tetravalence in this mixed solution, the reducing reaction reduces the ion of the metal and deposits the metal to form the metallic powder.

In this method, the tetravalent titanium ion already existing in the system acts as a growth inhibitor, which suppresses the growth of the metallic particles at the time of the reductive deposition. A plurality of the trivalent and tetravalent titanium ions form a cluster in the reductant solution. They exist in the state of hydration and complex formation as a whole. Consequently, a cluster has two functions: a function to grow the metallic particle by the trivalent titanium ion and the other function to suppress the growth of the metallic particle by the tetravalent titanium ion. While acting on the same metallic particle, the two functions form the metallic particle and the metallic powder in which a multitude of metallic particles are linked.

This process enables the easy production of the above-described minute metallic particle having an average particle diameter of at most 400 nm. Furthermore, in this production method, the control of the electrolysis conditions can adjust existing ratio between the trivalent and tetravalent titanium ions in the reductant solution. This adjustment enables the control of the ratio of the foregoing opposing functions of the two ions in the cluster. As a result, the diameter of the metallic particle can be controlled as required.

In addition, when the deposition is further continued, a metallic layer is further deposited on the surface of the metallic powder to strongly bond the metallic particles with one another. In other words, the above-described method produces the following members:

(i) the metallic powders 11A and 11B described in (a) and (b) above;

(ii) the metallic particles m1 for forming the metallic powders 11A and 11B; and

(iii) the cores m5a in the composites m5 for forming the metallic powders 11E and 11F described in (e) and (f) above.

The metallic particles m1 and the cores m5a have a uniform particle diameter, showing a sharp particle-size distribution. This is attributable to the fact that the reducing reaction proceeds uniformly in the system.

Consequently, the metallic powders 11A to 11F produced by using the above-explained metallic particles m1 and the cores m5a and the catalytic powders using the metallic powders 11A to 11F as the nucleus have superior dispersibility in the vehicle. After the deposition of the metallic particles and cores, the reductant solution can be electrolytically reconditioned as described above. Therefore, the solution can be used repeatedly to produce the chain-shaped metallic powder by the reductive deposition method. More specifically, after the deposition of the metallic particles and cores, the reductant solution is put into an electrolytic bath to reduce the tetravalent titanium ion to the trivalent titanium ion by applying a voltage. After this operation, the solution can be used again as the reductant solution for the reductive deposition. This is because the titanium ion is practically not consumed at the time of the reductive deposition. In other words, the titanium ion is not deposited together with the depositing metal.

The types of paramagnetic metals and alloys used for forming the metallic particles and cores include Ni, Fe, Co, and alloys comprising at least two of them. In particular, it is desirable to use Ni, Co, or an Ni—Fe alloy (Permally). Metallic particles, in particular, formed by using these metals and alloys have a strong magnetic interaction when they are linked to form a chain. Therefore, they are superior in reducing contact resistance between the metallic particles.

The types of other metals to be used to form the composites described in (c), (d), (e), and (f) above together with the paramagnetic metal and alloy include Ag, Cu, Al, Au, Rh, and other metals that have an ionization potential higher than the base metal.

In the composite, the portion formed by the foregoing other metal may be formed by various film-forming methods such as electroless plating, electroplating, reductive deposition, and vacuum evaporation.

(Catalytic Powder (Type I))

The catalytic powder incorporating the chain-shaped metallic powder as the nucleus is formed by coating, for example, one of the chain-shaped metallic powders 11A to 11F described in (a) to (f) above with the earlier-described catalytic metal (1) or metal (2).

Alternatively, the catalytic powder can be produced by using the catalytic metal (1) or the metal (2) as the other metal for forming the composite described in (c), (d), (e), and (f) above.

As with the composite, the chain-shaped metallic powders can be coated with the catalytic metal (1) or the metal (2) by using various film-forming methods such as electroless plating, electroplating, reductive deposition, and vacuum evaporation.

It is desirable that the catalytic powder have an average particle diameter of at most 3 μm. When the average particle diameter falls within this limit, the dispersibility of the catalytic powder in the vehicle can be improved. As a result, the catalytic powder can be more uniformly dispersed on the surface of the underlying film. Consequently, a metallic film can be grown more uniformly and nearly simultaneously on the entire surface of the underlying film by electroless plating, so that a metallic film is formed with a more uniform thickness and a more uniform crystal structure.

Furthermore, the catalytic powder can form a good conductive network in the underlying film. The network can give a good conductivity to the underlying film so that the underlying film can be used as the current-feeding portion at the time of electroplating. The chain-shaped catalytic powder may be used either singly or together with the chain-shaped metallic powder used as the conductive component. In the latter case, the catalytic powder in cooperation with the metallic powder can form a better conductive network.

(Catalytic Powder (Type II))

The catalytic powder having a shape other than the chain, such as a granular shape, can be at least one of the followings, for example:

(i) a catalytic powder having a single structure formed solely by the catalytic metal (1) or the metal (2); and

(ii) a catalytic powder having a composite structure formed by coating the catalytic powder's non-chain-shaped nucleus, such as a granular nucleus, made of metal, synthetic resin, or ceramic with the catalytic metal (1) or the metal (2).

The catalytic powder in (i) above can be produced by various methods, such as mechanical pulverizing, atomizing, vapor-phase reduction, chemical vapor deposition (CVD), physical vapor deposition (PVD), electrolytic deposition, and reductive deposition, by using the catalytic metal (1) or the metal (2) as the material. The catalytic powder in (ii) above can be produced by coating the nucleus formed by the various well-known methods with the catalytic metal (1) or the metal (2) by using the above-described various film-forming methods such as electroless plating, electroplating, reductive deposition, and vacuum evaporation.

The non-chain-shaped, such as granular, catalytic powder can be used singly. However, it is desirable to use it together with the chain-shaped catalytic powder or the chain-shaped metallic powder used as the conductive component considering the use of the underlying film as the current-feeding portion at the time of electroplating. In this case, it is desirable that the non-chain-shaped catalytic powder have a particle diameter smaller than that of the chain-shaped catalytic powder or the chain-shaped metallic powder. In particular, it is desirable that the average particle diameter be at most 400 nm.

The non-chain-shaped, such as granular, catalytic powder having a particle diameter falling within the foregoing limit can disperse uniformly on the surface portion of the underlying film by filling the interstices produced by the chain-shaped catalytic powders and metallic powders. Consequently, a metallic film can be grown more uniformly and nearly simultaneously on the entire surface of the underlying film by electroless plating, so that a metallic film is formed with a more uniform thickness and a more uniform crystal structure.

(Vehicle)

The paste for electroless plating comprises the foregoing catalytic powder and a vehicle. The vehicle can be any of the well-known compounds used as the vehicle for the conventional conductive paste. The types of the vehicle include a thermoplastic resin, a curable resin, and a liquid curable resin. In particular, it is desirable to use an acrylic resin, a fluororesin, or a phenolic resin.

(Paste for Electroless Plating)

The paste for electroless plating is produced by mixing at predetermined ratios the catalytic powder, the vehicle, and, as required, the metallic powder as the conductive component together with a proper solvent. The use of a liquid vehicle such as a liquid curable resin can eliminate the need for the solvent. The ratios of the ingredients are not particularly limited. However, it is desirable that the ratio of the catalytic powder to the total amount of the solid portion (summation of the amounts of the catalytic powder and vehicle) be 5 to 95 wt. %.

If the ratio of the catalytic powder is less than 5 wt. %, the catalytic powder cannot be uniformly dispersed on the surface of the underlying film with sufficient density. As a result, the electroless plating may not form a good metallic film on the surface. If the ratio of the catalytic powder is more than 95 wt. %, the percentage of the vehicle becomes insufficient. Therefore, an underlying film having sufficient strength may not be formed.

In the above description, when the chain-shaped catalytic powder or the non-chain-shaped catalytic powder is used singly, the ratio of the catalytic powder means the ratio of the used catalytic powder. When two or more differently shaped catalytic powders are used in combination, the ratio of the catalytic powder means the ratio of the total amount of the used catalytic powders to the total amount of the solid portion.

When the catalytic powder is used in combination with the metallic powder as the conductive component, it is desirable that the ratio of the total amount of the two ingredients to the total amount of the solid portion (summation of the amounts of the catalytic powder, metallic powder, and vehicle) be 5 to 95 wt. %, which is the same figure as that described above, and concurrently that the ratio of the catalytic powder to the total amount of the catalytic powder and metallic powder be 5.3 to 50 wt. %. If the ratio of the catalytic powder is less than the specified lower limit, the catalytic powder cannot be uniformly dispersed on the surface of the underlying film with sufficient density. As a result, the electroless plating may not form a good metallic film on the surface. If the ratio of the catalytic powder is more than the specified upper limit, the catalytic effect cannot be improved with an intended extent. Furthermore, the cost reduction effect resulting from the decrease in the amount of the catalytic powder by the addition of the metallic powder may be decreased.

<Method of Producing a Metallic Structured Body>

According to one aspect of the present invention, the present invention offers a method of producing a metallic structured body. The method comprises the following steps:

(a) preparing the paste for electroless plating of the present invention;

(b) preparing a precursor of the metallic structured body, the precursor having a three-dimensional structure;

(c) applying the paste onto the surface of the precursor to form an underlying film; and

(d) growing a metallic film on the surface of the underlying film through electroless plating by exploiting the catalytic function of the catalytic powder exposed on the surface of the underlying film.

This structure can exploit the effect of the electroless plating that utilizes the catalytic function of the above-described catalytic metal. As a result, a metallic film having a uniform crystal structure can be formed on the surface of the precursor. The metallic film has the intrinsic grain size of the crystal of the metal throughout its thickness. Consequently, the metallic structured body can have the intended good physical, mechanical, and electrical properties the metal inherently has.

It is desirable that in the method of producing a metallic structured body, the surface of the catalytic powder be formed by the metal (2) and that the method further comprise the step of bringing the metal (2) of the catalytic powder exposed on the surface of the underlying film into contact with a solution containing the ion of the catalytic metal (1) to partially replace the metal (2) with the catalytic metal (1) so that the catalytic powder can obtain a catalytic function.

The addition of this step enables the partial replacement of the metal (2) on the surface of the catalytic powder with the catalytic metal (1) to give the catalytic powder a catalytic function. The replacement is performed only at the required minimum region to function as a catalyst, which is the surface portion of the catalytic powder exposed on the surface of the underlying film. This added step can considerably reduce the production cost of the metallic structured body by decreasing the amount of the costly catalytic metal (1) to the required minimum.

It is desirable to add the step of further growing the metallic film by electroplating using as the electrode the metallic film grown by the electroless plating. The added electroplating can produce a metallic structured body having a thick metallic film difficult to produce solely by the electroless plating. Furthermore, the metallic film formed by the foregoing method has a uniform crystal structure in which the portion grown by the electroplating continuously lies on the portion formed by the electroless plating throughout its thickness. As a result, a metallic structured body having good properties can be produced without impairing the intended physical, mechanical, and electrical properties the metal inherently has.

(Electroless Plating)

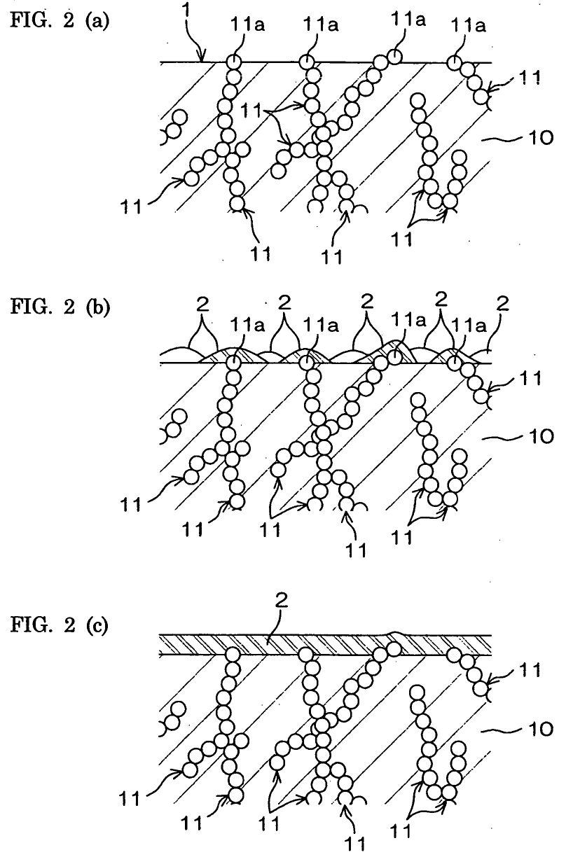

In the production method of the metallic structured body of the present invention, the foregoing paste for electroless plating is first applied onto the surface of the precursor of the metallic structured body. Here, the precursor has a three-dimensional structure. Then, the applied paste is solidified by drying. Alternatively, when a curable resin is used as the vehicle in the paste, the resin is cured. Thus, an underlying film 1 is formed as shown in FIG. 2(a). In the underlying film 1, a multitude of catalytic powders 11 are dispersed in the solidified or cured vehicle 10.

As shown in FIG. 2(a), the catalytic powders 11 have the shape of a chain because they have a chain-shaped metallic powder as the nucleus. Consequently, some end portions 11a of the chains are exposed on the surface of the underlying film 1. When the catalytic powder 11 has a structure in which the nucleus is coated with the catalytic metal (1), the exposed end portion 11a of the catalytic powder 11 already has a catalytic function. In this case, therefore, the next step is electroless plating.

On the other hand, when the catalytic powder 11 has a structure in which the nucleus is coated with the metal (2) such as Sn or Zn, the surface of the underlying film 1 is brought into contact with a solution containing the ion of the catalytic metal (1), such as a palladium chloride solution. This process partially replaces the metal (2) exposed on the surface of the underlying film 1 with the catalytic metal (1) to give a catalytic function. Despite the increase of one step, as described before, this method can decrease the amount of the costly catalytic metal (1) to the required minimum. Therefore, this method is notably advantageous in reducing the cost.

Next, for example, the underlying film 1 is immersed in an electroless-plating liquid prepared as required. This immersion grows metallic films 2 on the surface of the underlying film 1 as shown in FIGS. 2(b) and 2(c) by the electroless plating that exploits the catalytic function of the catalytic powder exposed on the surface of the underlying film 1. As shown in FIG. 2(b), at first, the metallic films 2 begin growing separately at a multitude of end portions 11a of the catalytic powders 11 exposed on the surface of the underlying film 1. Then, as shown in FIG. 2(c), they are united into one metallic film 2 covering the entire surface of the underlying film 1.

(Electroplating)

Although not shown in the drawing, when a thick metallic film is required, in particular, electroplating is performed by using as the electrode the metallic film 2 formed by the foregoing step of electroless plating. More specifically, the metallic film 2 is used as the cathode. The anode is formed by a metal to be plated or platinum. The two electrodes are immersed in an electroplating liquid prepared as required. Application of a voltage can further grow the metallic film 2.

In this case, the underlying film 1 incorporating the chain-shaped catalytic powder 11 as shown in FIG. 2(a) and an underlying film incorporating both a catalytic powder and a chain-shaped metallic powder as the conductive component have good conductivity. More specifically, the chain-shaped catalytic powders 11 and other conductive components dispersed in the underlying film 1 come into contact with one another to form a good conductive network. Therefore, the underlying film can be used as the portion for feeding a current to the metallic film 2 from an electric power source. Although not shown in the drawing, the following structure may be employed. First, a conductive film incorporating a chain-shaped metallic powder is formed on the surface of the precursor. Then, the foregoing underlying film 1 is formed on the conductive film to perform electroplating by using both the conductive film and underlying film as the current-feeding portion.

(Heat Treatment)

When the metallic structured body is to be used as a metallic porous body suitable for use as, for example, the electrode plate of a battery, the porous body as the precursor and the vehicle 10 in the underlying film 1 may be removed by a heat treatment after the electroplating as described earlier. The conditions for the heat treatment are not particularly limited providing that the treating temperature is higher than the thermal decomposition temperature of the portion to be removed and lower than the melting point of the metal constituting the metallic porous body.

(Metallic Structured Body)

The metallic structured body thus produced can be used as a metallic porous body suitable for use as, for example, the electrode plate of a battery. Other applications include the production of a complicated metallic pipe with a unitary structure free of seams. The metallic pipe may have a structure in which pipes having different diameters are mutually connected or branches are formed at some midpoints. The metallic pipe can be produced by the following process. First, a synthetic resin precursor is produced in accordance with the shape of the specified metallic pipe. A metallic film having the structure of the present invention is grown on the surface of the precursor. Finally, the precursor is removed by a heat treatment. This process enables the production of the above-described complicated metallic pipe with a unitary structure free of seams (such a metallic pipe has so far been unable to be produced).

<Method of Producing a Micrometallic Component (Method I)>

According to another aspect of the present invention, the present invention offers a method of producing a micrometallic component using the paste for electroless plating of the present invention. The method comprises the following steps:

(a) preparing a paste for electroless plating of the present invention;

(b) preparing a substrate;

(c) preparing a mold form provided with a patterned through hole corresponding with the shape of the micrometallic component to be produced;

(d) applying the paste onto the substrate;

(e) overlaying the mold form on the applied paste;

(f) solidifying the paste while maintaining the overlaying condition to form an underlying film and to securely bond the mold form to the substrate at the same time so that a mold can be produced; and

(g) selectively growing a metallic film corresponding with the shape of the patterned through hole on the surface of the underlying film exposed at the patterned through hole of the mold by electroless plating utilizing the catalytic function of the catalytic powder exposed on the surface of the underlying film.

This structure can exploit the effect of the electroless plating that utilizes the catalytic function of the above-described catalytic metal. As a result, a metallic film having a uniform crystal structure similar to the foregoing one can be formed selectively on the surface of the underlying film exposed in the patterned through hole of the mold. Consequently, a micrometallic component having good properties can be produced.

It is desirable that in the method of producing the micrometallic component, the surface of the catalytic powder be formed by the metal (2) and that the method further comprise the step of bringing the metal (2) of the catalytic powder exposed on the surface of the underlying film into contact with a solution containing the ion of the catalytic metal (1) to partially replace the metal (2) with the catalytic metal (1) so that the catalytic powder can obtain a catalytic function. As with the description for the production method of the metallic structured body, this structure can considerably reduce the production cost of the micrometallic component by decreasing the amount of the costly catalytic metal (1) to the required minimum.

It is desirable to add to the steps for producing the micrometallic component the step of further growing the metallic film by electroplating using as the electrode the metallic film grown by the electroless plating. According to this structure, as with the description for the production method of the metallic structured body, the added electroplating can produce a micrometallic component having a thick metallic film difficult to produce solely by the electroless plating. Furthermore, the metallic film formed by the foregoing method has a uniform crystal structure in which the portion grown by the electroplating lies continuously on the portion formed by the electroless plating. As a result, a micrometallic component having good properties can be produced without impairing the intended physical, mechanical, and electrical properties the metal inherently has.

(Production of a Mold M)

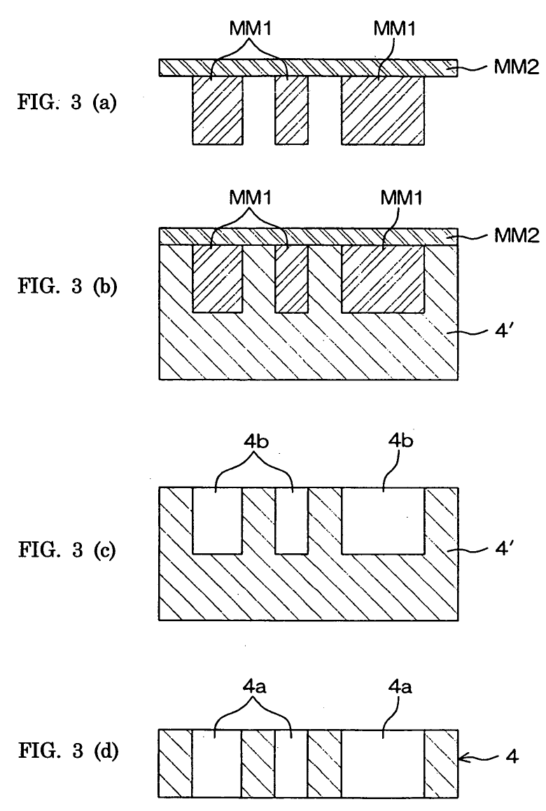

According to the production method of the micrometallic component of the present invention, a mold form 4 is first formed as shown in FIG. 3(d). The mold form 4 has a minute patterned through hole 4a corresponding with the shape of the micrometallic component.

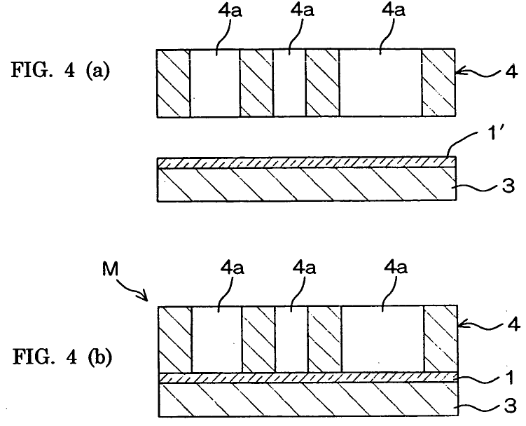

FIG. 3(d) schematically shows a part of a cross section of the mold form 4 for one product. Consequently, it appears that there exist a plurality of separated through holes 4a. However, when viewed from above, these through holes 4a are linked with one another to form one patterned through hole 4a. This explanation is to be applied to FIGS. 4(a), 4(b), 5(c), 6(a), and 6(b).

It is desirable that the mold form 4 be made of an insulating material such as synthetic resin to act as a mask at the time of the electroplating for further growing the metallic film formed by electroless plating (the electroplating uses the metallic film as the electrode).

It is desirable that the mold form 4 made of an insulating material such as synthetic resin be formed by a method such as injection molding or reactive injection molding that uses a master mold produced by the LIGA process, in particular. Here, the LIGA process is the micromachining technique that combines electroforming and X-ray deep lithography using synchrotron radiation (LIGA is the abbreviation of Lithographie (lithography) Galvanoformung (electroforming) Abformung (molding)).

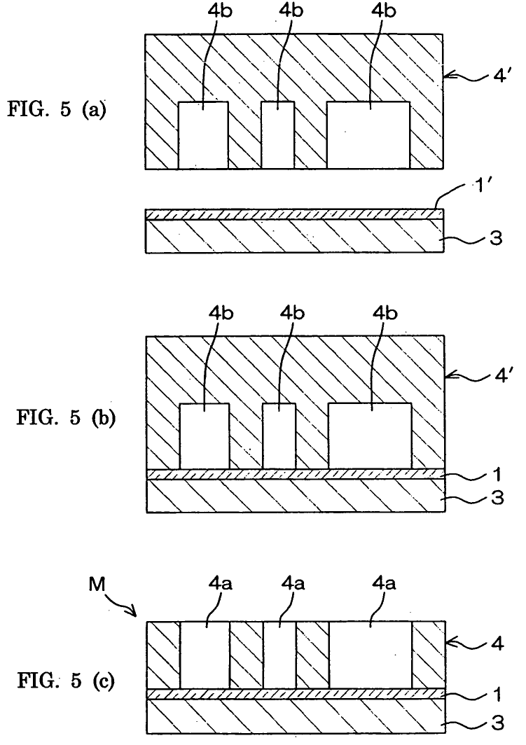

First, as shown in FIG. 3(a), a master mold MM1 having the shape of the micrometallic component is formed on a conductive substrate MM2 by using the X-ray deep lithography and electroforming. Next, a precursor 4′ of the mold form 4 is formed by the injection molding or reactive injection molding. The precursor 4′ has minute recessed portions 4b for forming a patterned through hole 4a corresponding with the shape of the master mold MM1. (See FIGS. 3(b) and 3(c).) As with the explanation for FIG. 3(d), the portions indicated by the sign “MM1” in FIGS. 3(a) and 3(b) are linked with one another to form one master mold MM1. A similar explanation is applied to the recessed portion 4b in FIG. 3(c). The same explanation is to be applied to FIGS. 5(a) and 5(b).

The mold form 4 is formed by polishing the precursor 4′ so that the recessed portion 4b can become a through hole. As can be seen from FIG. 3(d), the mold form 4 has a patterned through hole 4a corresponding with the shape of the master mold MM1. This method enables the repeated use of the master mold MM1 to form the mold form 4 on a mass production basis. As a result, the production cost of the micrometallic component can be reduced significantly over the conventional method.

According to the present invention, the subsequent process is shown in FIGS. 4(a) and 4(b). First, a paste for electroless plating 1′ of the present invention is applied onto the entire surface of a substrate 3. The mold form 4 is overlaid on the paste 1′. Then, the paste 1′ is solidified by drying. Alternatively, when a curable resin is used as the vehicle in the paste 1′, the resin is cured. Thus, an underlying film 1 is formed, and concurrently the mold form 4 is securely bonded to the substrate 3 to complete the production of a mold M.

An alternative method is shown in FIGS. 5(a) and 5(b). First, a paste for electroless plating 1′ is applied onto the entire surface of the substrate 3. The precursor 4′ of the mold form 4 shown in FIG. 3(c) is overlaid on the paste 1′ such that the recessed portions 4b face the paste 1′. Then, the paste 1′ is solidified by drying. Alternatively, when a curable resin is used as the vehicle in the paste 1′, the resin is cured. Thus, an underlying film 1 is formed, and concurrently the precursor 4′ is securely bonded to the substrate 3. Finally, the precursor 4′ is polished to expose the hidden recessed portions 4b so that they become one patterned through hole. This completes the production of the mold M.

It is desirable that the paste for electroless plating 1′ have an applied thickness of 0.5 to 70 μm, whichever method is used out of the foregoing two methods of producing the mold M. If the applied thickness is less than 0.5 μm, the paste 1′ cannot securely bond the mold form 4 to the substrate 3. As a result, the mold tends to become misaligned at the time of the electroless plating, for example. This tendency may reduce the reproducibility of the shape of the micrometallic component. On the other hand, if the applied thickness is more than 70 μm, the following problem may arise. When the mold form 4 is overlaid on the substrate 3, the stress at the time of the overlaying or the weight of the mold form 4 may squeeze the excessive amount of the paste. The squeezed large amount of the paste may become wavy or form blunt prominences like droplets in the patterned through hole 4a. If this occurs, the plating-starting surface becomes deformed, so that a plated film having a uniform crystal structure may not be formed. In some cases, the thickness-increased portion of the paste decreases the thickness of the plated film, so that a micrometallic component having the specified thickness may not be produced.

The substrate 3 can be formed by using various materials. However, when the metallic film 2 formed by the electroless plating is further grown by electroplating using the metallic film 2 as the electrode, a current must be fed to the metallic film 2 in the patterned through hole 4a. In this case, therefore, it is desirable that the substrate 3 be made of a metal, such as stainless steel, aluminum, or copper, or a composite formed by laminating a conductive layer on a material, such as silicon, glass, ceramic, or plastic, using the sputtering method, for example.

It is desirable that the insulating material for forming the mold form 4 be a synthetic resin that enables the application of a method such as injection molding or reactive injection molding as described above. The types of the synthetic resin include polymethyl methacrylate, polypropylene, polycarbonate, and epoxy resin.

(Electroless Plating)

In the mold M produced by the foregoing method, the surface portion of the underlying film 1 exposed in the patterned through hole 4a has a structure shown in FIG. 2(a). As can be seen from FIG. 2(a), a multitude of chain-shaped catalytic powders 11 having a chain-shaped metallic powder as the nucleus are dispersed in the solidified or cured vehicle 10. Some end portions 11a of the chains are exposed on the surface of the underlying film 1. In the underlying film 1, the chain-shaped catalytic powders 11 come into contact with one another to form a good conductive network.

When the catalytic powder 11 has a structure in which the nucleus is coated with the catalytic metal (1), the exposed end portion 11a of the catalytic powder 11 already has a catalytic function. In this case, therefore, the next step is electroless plating.

On the other hand, when the catalytic powder 11 has a structure in which the nucleus is coated with the metal (2) such as Sn or Zn, the surface of the underlying film 1 is brought into contact with a solution containing the ion of the catalytic metal (1), such as a palladium chloride solution. This process partially replaces the metal (2) exposed on the surface of the underlying film 1 with the catalytic metal (1) to give a catalytic function. This method can decrease the amount of the costly catalytic metal to the required minimum, enabling a notable reduction in the production cost of the micrometallic component.

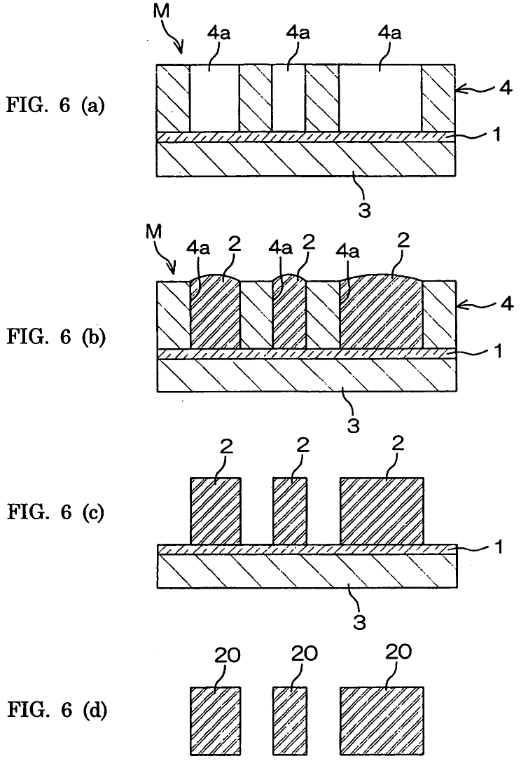

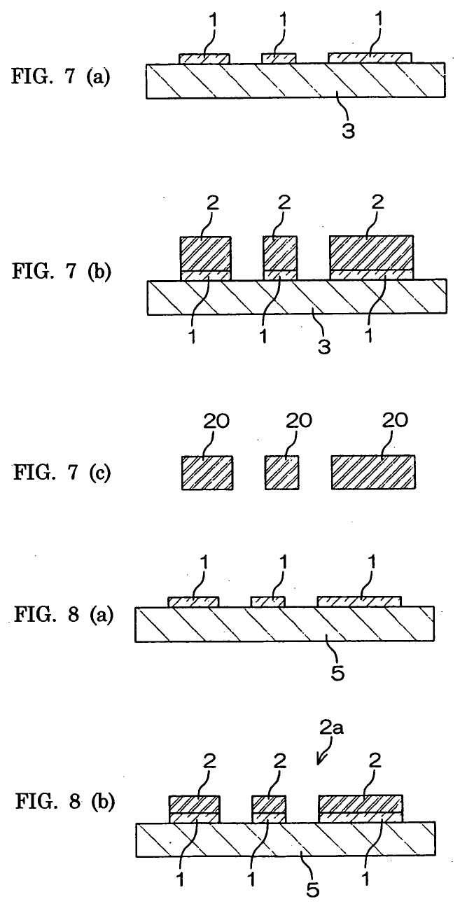

Next, for example, the mold M is immersed in an electroless-plating liquid prepared as required. This immersion selectively grows metallic film 2 on the surface of the underlying film 1 exposed in the patterned through hole 4a shown in FIG. 6(a). As explained in detail by referring to FIGS. 2(b) and 2(c), the electroless plating grows the metallic film 2 on the exposed surface of the underlying film 1 by exploiting the catalytic function of the end portions 11a of the catalytic powders 11 exposed on the surface of the underlying film 1. As with the explanation for FIG. 3(d), the portions indicated by the sign “2” in FIG. 6(b) are linked with one another to form one metallic film 2. The same explanation is to be applied to FIGS. 6(c) and 7(b).

(Electroplating)

As shown in FIG. 6(b), the metallic film 2 is first formed to the thickness that fills the entire patterned through hole 4a of the mold form 4. Then, the metallic film 2 is polished or ground together with the mold form 4 to meet the specified thickness. Thus, the micrometallic component having the specified thickness can be produced.

Although not shown in the drawing, the growth of the metallic film 2 can be terminated at some midpoint of the patterned through hole 4a of the mold form 4 immediately after its thickness reaches the specified thickness of the micrometallic component. This method can eliminate the need for the above-described polishing process.

It requires a prolonged time to grow the entire metallic film 2 having the specified thickness solely by the electroless plating. Therefore, it is desirable to grow the metallic film 2 to the specified thickness by electroplating using as the electrode the metallic film 2 grown to some extent by the electroless plating. More specifically, the metallic film 2 is used as the cathode. The anode is formed by a metal to be plated or platinum. The two electrodes are immersed in an electroplating liquid prepared as required. Application of a voltage can further grow the metallic film.

In this case, the underlying film 1 incorporating the chain-shaped catalytic powder 11 as shown in FIG. 2(a) and an underlying film incorporating both a catalytic powder and a chain-shaped metallic powder as the conductive component have good conductivity. More specifically, the chain-shaped catalytic powders 11 and other conductive components dispersed in the underlying film 1 come into contact with one another to form a good conductive network. Therefore, the underlying film can be used as the portion for feeding a current to the metallic film 2 from an electric power source through the conductive substrate 3. Although not shown in the drawing, the following structure may be employed. First, a conductive film incorporating a chain-shaped metallic powder is formed on the surface of the substrate 3. Then, the foregoing underlying film 1 is formed on the conductive film to perform electroplating by using both the conductive film and underlying film as the current-feeding portion.

Next, the mold form 4 is removed as shown in FIG. 6(c). The mold form 4 must be removed without the deformation of the metallic film 2 due to the application of an excessive stress. Therefore, it is desirable to use a noncontact method, such as ashing using an oxygen plasma or decomposition by the irradiation of X-rays or ultraviolet rays. Finally, the removal of the underlying film 1 and the substrate 3 completes the production of a micrometallic component 20 having a minute three-dimensional structure corresponding with the shape of the patterned through hole 4a as shown in FIG. 6(d). As with the explanation for FIG. 3(d), the portions indicated by the sign “20” in FIG. 6(d) are linked with one another to form one micrometallic component 20. The same explanation is to be applied to FIG. 7(c).

It is desirable to remove the underlying film 1 and the substrate 3 by dissolving the underlying film 1 using a proper solvent or by decomposing the underlying film 1 using dry etching. After this treatment, the remaining substrate 3 can be readily removed.

<Method of Producing a Micrometallic Component (Method II)>

According to yet another aspect of the present invention, the present invention offers another method of producing a micrometallic component using the paste for electroless plating of the present invention. The method comprises the following steps:

(a) preparing a paste for electroless plating of the present invention;

(b) preparing a substrate;

(c) on the substrate, forming by using the paste the pattern of an underlying film corresponding with the shape of the micrometallic component to be produced; and

(d) selectively growing a metallic film corresponding with the shape of the underlying film on the surface of the underlying film on the substrate by electroless plating utilizing the catalytic function of the catalytic powder exposed on the surface of the underlying film.

This structure can exploit the effect of the electroless plating that utilizes the catalytic function of the above-described catalytic metal. As a result, a metallic film having a uniform crystal structure similar to the foregoing one can be formed selectively on the surface of the pattern of the underlying film formed on the substrate. Consequently, a micrometallic component having good properties can be produced.

It is desirable that in the method of producing the micrometallic component, the surface of the catalytic powder be formed by the metal (2) and that the method further comprise the step of bringing the metal (2) of the catalytic powder exposed on the surface of the underlying film into contact with a solution containing the ion of the catalytic metal (1) to partially replace the metal (2) with the catalytic metal (1) so that the catalytic powder can obtain a catalytic function. As with the description for the production method of the metallic structured body, this structure can considerably reduce the production cost of the micrometallic component by decreasing the amount of the costly catalytic metal (1) to the required minimum.

It is desirable to add to the steps for producing the micrometallic component the step of further growing the metallic film by electroplating using as the electrode the metallic film grown by the electroless plating. The added electroplating can produce a micrometallic component having a thick metallic film difficult to produce solely by the electroless plating. Furthermore, the metallic film formed by the foregoing method also has a continuous, uniform crystal structure throughout the thickness. As a result, a micrometallic component having good properties can be produced without impairing the intended physical, mechanical, and electrical properties the metal inherently has.

When the micrometallic component is not particularly thick or sufficiently thin in comparison with the two-dimensional shape, it is effective to apply this Method II.

First, as shown in FIG. 7(a), on the substrate 3, the pattern of an underlying film 1 corresponding with the shape of the micrometallic component is formed using the above-described paste for electroless plating. It is desirable that the pattern formation of the underlying film 1 be performed by a printing method such as screen printing or offset printing. These printing methods can form the pattern of the underlying film 1 corresponding with the shape of the micrometallic component through simpler and fewer steps.

The surface portion of the formed pattern of the underlying film 1 also has a structure shown in FIG. 2(a). As can be seen from FIG. 2(a), a multitude of chain-shaped catalytic powders 11 having a chain-shaped metallic powder as the nucleus are dispersed in the solidified or cured vehicle 10. Some end portions 11a of the chains are exposed on the surface of the underlying film 1. In the underlying film 1, the chain-shaped catalytic powders 11 come into contact with one another to form a good conductive network.

When the catalytic powder 11 has a structure in which the nucleus is coated with the catalytic metal (1), the exposed end portion 11a of the catalytic powder 11 already has a catalytic function. In this case, therefore, the next step is electroless plating.

On the other hand, when the catalytic powder 11 has a structure in which the nucleus is coated with the metal (2) such as Sn or Zn, the surface of the underlying film 1 is brought into contact with a solution containing the ion of the catalytic metal (1), such as a palladium chloride solution. This process partially replaces the metal (2) exposed on the surface of the underlying film 1 with the catalytic metal (1) to give a catalytic function.

Next, for example, the substrate 3 provided with the underlying film 1 is immersed in an electroless-plating liquid prepared as required. This immersion selectively grows metallic film 2 on the surface of the formed pattern of the underlying film 1 as shown in FIG. 7(b). As explained in detail by referring to FIGS. 2(b) and 2(c), the electroless plating grows the metallic film 2 on the surface of the underlying film 1 by exploiting the catalytic function of the end portions 11a of the catalytic powders 11 exposed on the surface of the underlying film 1.

As described above, when the micrometallic component is not particularly thick, an application of the electroless plating alone may be sufficient. If necessary, however, electroplating may be performed to further grow the metallic film 2. More specifically, the electroplating can be performed either by feeding a current directly to the metallic film 2 formed by the electroless plating or by feeding a current through the substrate 3 and the underlying film 1. Thus, the metallic film 2 can be further grown.

When the current is fed through the substrate 3 and the underlying film 1, the substrate 3 is formed by using a metal or a composite as explained earlier. The underlying film 1 is formed with a structure in which either the above-described chain-shaped catalytic powder is included or a chain-shaped metallic powder is added. Thus, the underlying film 1 can have a good conductivity.

Although not shown in the drawing, the following structure may be employed to perform the electroplating. First, a conductive film incorporating a chain-shaped metallic powder is formed on the surface of the substrate 3. Then, the foregoing underlying film 1 is formed on the conductive film. Thus, the electroplating is performed by using both the conductive film and underlying film as the current-feeding portion.

As described above, the metallic film 2 is grown until it has a specified thickness either by electroless plating alone or by electroless plating followed by electroplating. Then, the underlying film 1 is removed either by dissolving it using a proper solvent or by decomposing it using dry etching. Finally, the removal of the substrate 3 completes the production of a micrometallic component 20 having a minute three-dimensional structure corresponding with the shape of the pattern of the underlying film 1 (see FIG. 7(c)). This method facilitates the production of the micrometallic component.

The use of the paste for electroless plating of the present invention enables the production of not only the foregoing metallic structured body and micrometallic component but also other metallic products having various shapes and structures either by electroless plating alone or by electroless plating followed by electroplating. The concrete examples of the other metallic products include a conductor circuit formed with a specified shape on an insulating substrate.

<Method of Producing a Conductor Circuit>

A conductor circuit is produced by using the paste for electroless plating of the present invention and through the following process. First, as shown in FIG. 8(a), the pattern of an underlying film 1 corresponding with the shape of the conductor circuit is formed using the paste on an insulating substrate 5. It is desirable that the pattern formation of the underlying film 1 be performed by a printing method such as screen printing or offset printing.

The surface portion of the formed pattern of the underlying film 1 also has a structure shown in FIG. 2(a). As can be seen from FIG. 2(a), a multitude of chain-shaped catalytic powders 11 having a chain-shaped metallic powder as the nucleus are dispersed in the solidified or cured vehicle 10. Some end portions 11a of the chains are exposed on the surface of the underlying film 1. In the underlying film 1, the chain-shaped catalytic powders 11 come into contact with one another to form a good conductive network.

When the catalytic powder 11 has a structure in which the nucleus is coated with the catalytic metal (1), the next step is electroless plating.

On the other hand, when the catalytic powder 11 has a structure in which the nucleus is coated with the metal (2) such as Sn or Zn, the surface of the underlying film 1 is brought into contact with a solution containing the ion of the catalytic metal (1), such as a palladium chloride solution. This process partially replaces the metal (2) exposed on the surface of the underlying film 1 with the catalytic metal (1) to give a catalytic function.

Next, for example, the insulating substrate 5 provided with the underlying film 1 is immersed in an electroless-plating liquid prepared as required. This immersion selectively grows a metallic film 2 on the surface of the pattern of the underlying film 1 as shown in FIG. 8(b). As explained in detail by referring to FIGS. 2(b) and 2(c), the electroless plating grows the metallic film 2 on the surface of the underlying film 1 by exploiting the catalytic function of the end portions 11a of the catalytic powders 11 exposed on the surface of the underlying film 1. This process forms a conductor circuit 2a composed of the metallic film 2.

In this case also, if necessary, electroplating may be performed to further grow the metallic film 2 by using it as the electrode. Because the substrate is an insulator, the electroplating is performed either by feeding a current directly to the metallic film 2 or by feeding a current through the underlying film 1. Although not shown in the drawing, the following structure may be employed to perform the electroplating. First, a conductive film incorporating a chain-shaped metallic powder is formed on the surface of the substrate 5. Then, the foregoing underlying film 1 is formed on the conductive film. Thus, the current can be fed through the conductive film and underlying film.

Embodiments

The present invention is explained below based on Examples and Comparative examples.

<Paste for Electroless Plating>

### EXAMPLE 1

(Production of a Catalytic Powder)

The nucleus of a catalytic powder was formed by using an Ni powder having a structure in which a multitude of minute metallic powders were linked so as to form a chain, wherein the metallic powders had a diameter of 100 nm and the chain had a diameter of 200 nm. The Ni powder was coated with Pd as a catalytic metal by electroless plating. Thus, the catalytic powder having an average particle diameter of 1 μm was produced.

(Preparation of a Paste for Electroless Plating)

A paste for electroless plating was prepared by mixing 20 parts by weight of the foregoing catalytic powder and 80 parts by weight of thermosetting acrylic syrup, which is a liquid curable resin. The ratio of the catalytic powder to the total amount of the two ingredients was 20 wt. %.

### EXAMPLE 2

The nucleus of a catalytic powder was formed by using the same Ni powder as used in Example 1. The surface of the Ni powder was treated with an Sn colloidal solution to adsorb Sn. Thus, a catalytic powder composed of an Ni powder coated with Sn was produced. The catalytic powder had an average particle diameter of 1 μm.

A paste for electroless plating was prepared by the same method as used in Example 1 except that the foregoing catalytic powder was used. The ratio of the catalytic powder to the total amount of the two ingredients was 20 wt. %.

### COMPARATIVE EXAMPLE 1

A paste for electroless plating was prepared by the same method as used in Example 1 except that the same Ni powder as used in Example 1 was used without any coating treatment. The ratio of the Ni powder to the total amount of the two ingredients was 20 wt. %. The Ni powder had an average particle diameter of 1 μm.

<Method of Producing a Metallic Structured Body)

### EXAMPLE 3

(Formation of an Underlying Film)

A precursor was formed by using a board of polyurethane foam having a thickness of 1.8 mm, an average pore diameter of 0.45 mm, and a porosity of 98% (the polyurethane foam had a continuous pore structure).

The paste for electroless plating prepared in Example 1 was applied onto the board of polyurethane foam. The applied paste was dried at 100° C. for four hours to set the resin. Thus, an underlying film for electroless plating was formed.

(Formation of a Metallic Film)

The board of polyurethane foam provided with the underlying film was immersed in an Ni electroless-plating bath having the below-described formula. The electroless plating grew an Ni film on the surface of the underlying film by exploiting the catalytic function of the Pd of the catalytic powder exposed on the surface of the underlying film. The Ni film had a thickness of 0.2 to 0.5 μm.

Ni electroless-plating bath (pH: 7.5 to 9.5)

| (Ingredient) | (Concentration) |
|---|---|
| Nickel sulfate | 30 g/L |
| Sodium hypophosphite | 20 g/L |
| Ammonium citrate | 50 g/L |

Next, a current-feeding terminal was attached to the Ni film on the board of polyurethane foam to form a current-feeding portion. The assembly was immersed in an Ni electroplating bath having the below-described formula. The electroplating was performed at a current density of 100 to 150 mA/cm² and a bath temperature of 40 to 60° C. for 30 minutes.

Ni electroplating bath (pH: 3.5 to 4.5)

| (Ingredient) | (Concentration) |
|---|---|
| Nickel sulfamate | 450 g/L |
| Boric acid | 30 g/L |

The electroplating increased the thickness of the Ni film on the underlying film to 10 to 50 μm. The Ni film had a volume resistivity of 8×10⁻⁶ Ω·cm.

After the electroplating, the cross section of the formed Ni film was observed with a metallurgical microscope. The size of the crystal grain of the Ni film was measured at a position 5% of the thickness away from the underlying film and at a position 5% of the thickness away from the surface. The size ratio of the crystal grain Rφ was calculated by using Eq. (1).

Rφ=φ₁/φ₂ (1),

where

φ₁: size of the crystal grain at the underlying film side

φ₂: size of the crystal grain at the surface side.

The obtained result of Rφ was 1.1. This confirmed that the variation in the size of the crystal grain was negligible and that the Ni film had a uniform crystal structure throughout its thickness.

(Heat Treatment)

After the foregoing measurement, the polyurethane foam was removed by thermally decomposing it at 1,000° C. for 30 minutes in an electric furnace having a hydrogen-reducing atmosphere. Thus, a metallic structured body having a porous structure was produced.

The metallic structured body was subjected to a test of 180-degree bending around a round bar having a diameter of 30 mm. The body was able to be bent smoothly along the surface of the bar without fracturing.

### EXAMPLE 4

(Formation of an Underlying Film)

The paste for electroless plating prepared in Example 2 was applied onto the same board of polyurethane foam as used in Example 3. The applied paste was dried at 100° C. for four hours to set the resin. Thus, an underlying film for electroless plating was formed.

(Formation of a Metallic Film)

The board of polyurethane foam provided with the underlying film was immersed in a palladium chloride solution having a concentration of 0.2 g/L. This immersion replaced the Sn of the catalytic powder exposed on the surface of the underlying film with Pd to give a catalytic function.

Subsequently, Ni electroless plating and Ni electroplating were carried out by a method similar to one used in Example 3 to form an Ni film having a thickness of 10 to 50 μm on the underlying film. The Ni film had a volume resistivity of 8×10⁻⁶ Ω·cm.

After the electroplating, the cross section of the formed Ni film was observed with a metallurgical microscope. The size of the crystal grain of the Ni film was measured at a position 5% of the thickness away from the underlying film and at a position 5% of the thickness away from the surface. The size ratio of the crystal grain Rφ was calculated by using Eq. (1) shown above. The calculation used φ₁ and φ₂ as described above, where φ₁ is the size of the crystal grain at the underlying film side, and φ₂, at the surface side. The obtained result of the ratio Rφ was 1.1. This confirmed that the variation in the size of the crystal grain was negligible and that the Ni film had a uniform crystal structure throughout its thickness.

(Heat Treatment)

After the foregoing measurement, the polyurethane foam was removed by thermally decomposing it under the same heat-treating conditions as used in Example 3. Thus, a metallic structured body having a porous structure was produced.

The metallic structured body was subjected to a test of 180-degree bending around a round bar having a diameter of 30 mm. The body was able to be bent smoothly along the surface of the bar without fracturing.

### COMPARATIVE EXAMPLE 2

(Formation of an Underlying Film)

The paste for electroless plating prepared in Comparative example 1 was applied onto the same board of polyurethane foam as used in Example 3. The applied paste was dried at 100° C. for four hours to set the resin. Thus, an underlying film for electroless plating was formed.

(Formation of a Metallic Film)

The board of polyurethane foam provided with the underlying film was treated with the following plating. Ni electroless plating and Ni electroplating were carried out by a method similar to one used in Example 3 to form an Ni film having a thickness of 10 to 50 μm on the underlying film. The Ni film had a volume resistivity of 8×10⁻⁶ Ω·cm.

After the electroplating, the cross section of the formed Ni film was observed with a metallurgical microscope. The size of the crystal grain of the Ni film was measured at a position 5% of the thickness away from the underlying film and at a position 5% of the thickness away from the surface. The size ratio of the crystal grain Rφ was calculated by using Eq. (1) shown above. The calculation used φ₁ and φ₂ as described above, where φ₁ is the size of the crystal grain at the underlying film side, and φ₂, at the surface side. The obtained result of the ratio Rφ was 2.0. The observation revealed that the crystal at the underlying film side had a coarse grain size with low density and that the crystal at the surface side had a fine grain size with high density. In other words, the Ni film had a discontinuous crystal structure.

(Heat Treatment)

After the foregoing measurement, the polyurethane foam was removed by thermally decomposing it under the same heat-treating conditions as used in Example 3. Thus, a metallic structured body having a porous structure was produced.

The metallic structured body was subjected to a test of 180-degree bending around a round bar having a diameter of 30 mm. The body was unable to be bent smoothly along the surface of the bar, and its structure at the inside of the bending fractured.

<Method of Producing a Micrometallic Component (Method I)>

### EXAMPLE 5

(Production of a Mold)

First, a mold form 4 having a thickness of 200 μm was produced by the LI-GA process. As shown in FIG. 4(a), the form 4 had a patterned through hole 4a corresponding with the shape of the micrometallic component. The patterned through hole 4a had a width of 10 mm and a length of 50 mm (the width is the dimension parallel to the face of the paper, and the length is the dimension perpendicular to the face of the paper).

Next, as shown in FIG. 4(a), the paste for electroless plating 1′ prepared in Example 1 was applied with a blade coater onto a metallic substrate 3, which was coated with a Ti-sputtered film. The applied paste had a thickness of 5 μL m. The mold form 4 was overlaid on the applied paste 1′. Then, the resin was set by heating it at 100° C. for four hours while a pressing force of 0.1 MPa was applied onto the mold form 4. Thus, an underlying film 1 was formed, and concurrently the mold form 4 was securely bonded to the substrate 3 to complete the production of a mold M (see FIG. 4(b)).

(Production of a Micrometallic Component)

The mold M was immersed in the same Ni electroless-plating bath as used in Example 3. As shown in FIG. 6(b), the electroless plating selectively grew an Ni film 2 on the surface of the underlying film 1 exposed in the patterned through hole 4a by exploiting the catalytic function of the Pd of the catalytic powder exposed on the surface of the underlying film 1. The Ni film 2 had a thickness of 0.2 to 5 μm.

Next, a current-feeding terminal was attached to the substrate 3 to form a current-feeding portion. The assembly was immersed in the same Ni electroplating bath as used in Example 3. The electroplating was performed at a current density of 10 to 150 mA/cm² and a bath temperature of 40 to 60° C. The electroplating of the Ni film 2 was terminated when its thickness reached about half the height of the patterned through hole 4a. Then, the assembly was taken out of the bath to wash it thoroughly with water. The mold form 4 was decomposed and removed with ashing using an oxygen plasma as shown in FIG. 6(c). The portion of the underlying film 1 directly under the mold form 4 was also removed together with the mold form 4. The Ti-sputtered film was dissolved by wet etching to remove the substrate 3. The remaining portion of the underlying film 1 directly under the Ni film 2 was removed by dissolving it with a solvent. Thus, a micrometallic component 20 corresponding with the shape of the patterned through hole 4a was produced as shown in FIG. 6(d). The micrometallic component had a width of 10 mm, a length of 50 mm, and a thickness of 100 μm.

A strip having a width of 5 mm was die-cut from the produced micrometallic component 20 to perform a tensile test. The obtained tensile strength was 1,000 MPa, which is comparable to that of Ni bulk products. This result confirmed that the micrometallic component 20 produced in Example 5 had crystal grains having the intrinsic grain size of the metal from the early stage of the growth. As a result, the entire component 20 had a uniform crystal structure. This single layer structure enables the attainment of the intended physical, mechanical, and electrical properties. In short, the micrometallic component 20 produced in Example 5 has good properties.

### EXAMPLE 6

(Production of a Mold)

First, the paste for electroless plating prepared in Example 2 was applied onto the same metallic substrate 3 as used in Example 5, which was coated with a Ti-sputtered film. The application was performed under the same conditions as in Example 5. The same mold form 4 as used in Example 5 was overlaid on the applied paste. Then, the resin was set by heating it at 100° C. for four hours while the same pressing force as used in Example 5 was applied onto the mold form 4. Thus, an underlying film 1 was formed, and concurrently the mold form 4 was securely bonded to the substrate 3 to complete the production of a mold M (see FIG. 4(b)).

(Production of a Micrometallic Component)

The mold M was immersed in a palladium chloride solution having a concentration of 0.2 g/L. This immersion replaced the Sn of the catalytic powder exposed on the surface of the underlying film with Pd to give a catalytic function. Subsequently, Ni electroless plating and Ni electroplating were performed with a method similar to one used in Example 5. Thus, a micrometallic component 20 having the same shape and dimensions as in Example 5 was produced (see FIGS. 6(a) to 6(d)).

A strip having a width of 5 mm was die-cut from the produced micrometallic component 20 to perform a tensile test. The obtained tensile strength was 1,000 MPa, which is comparable to that of Ni bulk products. This result confirmed that the micrometallic component 20 produced in Example 6 also had crystal grains having the intrinsic grain size of the metal from the early stage of the growth. As a result, the entire component 20 had a uniform crystal structure. This single layer structure enables the attainment of the intended physical, mechanical, and electrical properties. In short, the micrometallic component 20 produced in Example 6 has good properties.

### COMPARATIVE EXAMPLE 3

(Production of a Mold)

First, the paste for electroless plating prepared in Comparative example 1 was applied onto the same metallic substrate 3 as used in Example 5, which was coated with a Ti-sputtered film. The application was performed under the same conditions as in Example 5. The same mold form 4 as used in Example 5 was overlaid on the applied paste. Then, the resin was set by heating it at 100° C. for four hours while the same pressing force as used in Example 5 was applied onto the mold form 4. Thus, an underlying film 1 was formed, and concurrently the mold form 4 was securely bonded to the substrate 3 to complete the production of a mold M (see FIG. 4(b)).

(Production of a Micrometallic Component)

The mold M was plated by Ni electroless plating and Ni electroplating with a method similar to one used in Example 5. Thus, a micrometallic component 20 having the same shape and dimensions as in Example 5 was produced (see FIGS. 6(a) to 6(d)).

A strip having a width of 5 mm was die-cut from the produced micrometallic component 20 to perform a tensile test. The obtained tensile strength was 600 MPa, which is significantly lower than that of Ni bulk products.

This result revealed that the micrometallic component 20 produced in Comparative example 3 had crystal grains having the size different from the intrinsic grain size of the metal at the early stage of the growth. As a result, the crystal structure was discontinuous in the thicknesswise direction. Therefore, the component 20 produced in Comparative example 3 is unable to attain the intended physical, mechanical, and electrical properties.

>Method of Producing a Micrometallic Component (Method II)>

### EXAMPLE 7

(Pattern Formation of an Underlying Film)

As shown in FIG. 7(a), the paste for electroless plating 1′ prepared in Example 1 was printed by screen printing onto an Si substrate 3, which was coated with a Ti-sputtered film. Then, the resin was set by heating it at 100° C. for four hours. Thus, the pattern of an underlying film 1 having a width of 10 mm, a length of 50 mm, and a thickness of 1 μm was formed.

(Production of a Micrometallic Component)

The substrate 3 provided with the underlying film 1 was immersed in the same Ni electroless-plating bath as used in Example 3. As shown in FIG. 7(b), the electroless plating selectively grew an Ni film 2 on the surface of the underlying film 1 by exploiting the catalytic function of the Pd of the catalytic powder exposed on the surface of the underlying film 1. The Ni film 2 had a thickness of 0.2 to 0.5 μm.

Next, a current-feeding terminal was attached to the Ti-sputtered film on the substrate 3 to form a current-feeding portion. The assembly was immersed in the same Ni electroplating bath as used in Example 3. The electroplating was performed at a current density of 10 to 150 mA/cm² and a bath temperature of 40 to 60° C.

The electroplating of the Ni film 2 was terminated when its thickness reached 100 μm. Then, the assembly was taken out of the bath to wash it thoroughly with water. The Ti-sputtered film was dissolved and removed by wet etching to remove the substrate 3. The remaining underlying film 1 was removed by dissolving it with a solvent. Thus, a micrometallic component 20 corresponding with the shape of the pattern of the underlying film 1 was produced as shown in FIG. 7(c). The micrometallic component had a width of 10 mm, a length of 50 mm, and a thickness of 100 μm.

A strip having a width of 5 mm was die-cut from the produced micrometallic component 20 to perform a tensile test. The obtained tensile strength was 1,000 MPa, which is comparable to that of Ni bulk products.

This result confirmed that the micrometallic component 20 produced in Example 7 had crystal grains having the intrinsic grain size of the metal from the early stage of the growth. As a result, the entire component 20 had a uniform crystal structure. This single layer structure enables the attainment of the intended physical, mechanical, and electrical properties. In short, the micrometallic component 20 produced in Example 7 has good properties.

### EXAMPLE 8

(Pattern Formation of an Underlying Film)

As shown in FIG. 7(a), the paste for electroless plating 1′ prepared in Example 2 was printed by screen printing onto the same Si substrate 3 as used in Example 7, which was coated with a Ti-sputtered film. Then, the resin was set by heating it at 100° C. for four hours. Thus, the pattern of an underlying film 1 having a width of 10 mm, a length of 50 mm, and a thickness of 1 μm was formed

(Production of a Micrometallic Component)

The substrate 3 provided with the underlying film 1 was immersed in a palladium chloride solution having a concentration of 0.2 g/L. This immersion replaced the Sn of the catalytic powder exposed on the surface of the underlying film with Pd to give a catalytic function. Subsequently, Ni electroless plating and Ni electroplating were performed with a method similar to one used in Example 7. Thus, a micrometallic component 20 having the same shape and dimensions as in Example 7 was produced (see FIGS. 7(a) to 7(c)).

A strip having a width of 5 mm was die-cut from the produced micrometallic component 20 to perform a tensile test. The obtained tensile strength was 1,000 MPa, which is comparable to that of Ni bulk products.

This result confirmed that the micrometallic component 20 produced in Example 8 also had crystal grains having the intrinsic grain size of the metal from the early stage of the growth. As a result, the entire component 20 had a uniform crystal structure. This single layer structure enables the attainment of the intended physical, mechanical, and electrical properties. In short, the micrometallic component 20 produced in Example 8 has good properties.

### COMPARATIVE EXAMPLE 4

(Pattern Formation of an Underlying Film)

As shown in FIG. 7(a), the paste for electroless plating 1′ prepared in Comparative example 1 was printed by screen printing onto the same Si substrate 3 as used in Example 7, which was coated with a Ti-sputtered film. Then, the resin was set by heating it at 100° C. for four hours. Thus, the pattern of an underlying film 1 having a width of 10 mm, a length of 50 mm, and a thickness of 1 μm was formed

(Production of a Micrometallic Component)

The substrate 3 provided with the underlying film 1 was treated by Ni electroless plating and Ni electroplating with a method similar to one used in Example 7. Thus, a micrometallic component 20 having the same shape and dimensions as in Example 7 was produced (see FIGS. 7(a) to 7(c)).

A strip having a width of 5 mm was die-cut from the produced micrometallic component 20 to perform a tensile test. The obtained tensile strength was 600 MPa, which is significantly lower than that of Ni bulk products.

This result revealed that the micrometallic component 20 produced in Comparative example 4 had crystal grains having the size different from the intrinsic grain size of the metal at the early stage of the growth. As a result, the crystal structure was discontinuous in the thicknesswise direction. Therefore, the component 20 produced in Comparative example 4 is unable to attain the intended physical, mechanical, and electrical properties.

<Method of Producing a Conductor Circuit>

### EXAMPLE 9

(Pattern Formation of an Underlying Film)

As shown in FIG. 8(a), the paste for electroless plating 1′ prepared in Example 1 was printed by screen printing onto a thoroughly cleaned glass substrate 5. Then, the resin was set by heating it at 100° C. for four hours. Thus, the pattern of an underlying film 1 corresponding with the shape of an address electrode was formed. The film 1 had a thickness of 1 μm.

(Formation of a Conductor Circuit)

The substrate 5 provided with the underlying film 1 was immersed in the same Ni electroless-plating bath as used in Example 3. As shown in FIG. 8(b), the electroless plating selectively grew an Ni film 2 on the surface of the underlying film 1 by exploiting the catalytic function of the Pd of the catalytic powder exposed on the surface of the underlying film 1. The Ni film 2 had a thickness of 0.2 to 0.5 μm.

Next, a current-feeding terminal was attached to the Ni film 2 to form a current-feeding portion. The assembly was immersed in the same Ni electroplating bath as used in Example 3. The electroplating was performed at a current density of 10 to 150 mA/cm² and a bath temperature of 40 to 60° C.

The electroplating of the Ni film 2 was terminated when its thickness reached 10 μm. Then, the assembly was taken out of the bath to wash it thoroughly with water and dried. Thus, a conductor circuit 2a was formed (see FIG. 8(b)).

A measurement revealed that the obtained conductor circuit 2a had a volume resistivity of 8×10⁻⁶ Ω·cm. The circuit pattern had no break and no other defects. The observation of the cross section of the Ni film 2 forming the conductor circuit 2a revealed that the density was high and the shape was smooth without any unevenness. The surface roughness was measured by using an optical interferometer made by ZYGO Co. based in the U.S. The result showed that the center line average roughness Ra was less than 0.01 μm, confirming that the surface was extremely smooth.

### EXAMPLE 10

(Pattern Formation of an Underlying Film)

As shown in FIG. 8(a), the paste for electroless plating 1′ prepared in Example 2 was printed by screen printing onto a thoroughly cleaned glass substrate 5. Then, the resin was set by heating it at 100° C. for four hours. Thus, the pattern of an underlying film 1 corresponding with the shape of an address electrode was formed. The film 1 had a thickness of 1 μm.

(Formation of a Conductor Circuit)

The substrate 5 provided with the underlying film 1 was immersed in a palladium chloride solution having a concentration of 0.2 g/L. This immersion replaced the Sn of the catalytic powder exposed on the surface of the underlying film with Pd to give a catalytic function. Subsequently, Ni electroless plating and Ni electroplating were performed with a method similar to one used in Example 9. Thus, a conductor circuit 2a having the same shape and dimensions as in Example 9 was produced (see FIGS. 8(a) and 8(b)).

A measurement revealed that the obtained conductor circuit 2a had a volume resistivity of 8×10⁻⁶ Ω·cm. The circuit pattern had no break and no other defects. The observation of the cross section of the Ni film 2 forming the conductor circuit 2a revealed that the density was high and the shape was smooth without any unevenness. The surface roughness was measured by using an optical interferometer made by ZYGO Co. The result showed that the center line average roughness Ra was less than 0.01 μm, confirming that the surface was extremely smooth.

### COMPARATIVE EXAMPLE 5

(Pattern Formation of an Underlying Film)

As shown in FIG. 8(a), the paste for electroless plating 1′ prepared in Comparative example 1 was printed by screen printing onto a thoroughly cleaned glass substrate 5. Then, the resin was set by heating it at 100° C. for four hours. Thus, the pattern of an underlying film 1 corresponding with the shape of an address electrode was formed. The film 1 had a thickness of 1 μm.

(Formation of a Conductor Circuit)

The substrate 5 provided with the underlying film 1 was treated by Ni electroless plating and Ni electroplating with a method similar to one used in Example 9. Thus, a conductor circuit 2a having the same shape and dimensions as in Example 9 was produced (see FIGS. 8(a) and 8(b)).

A measurement revealed that the obtained conductor circuit 2a had a volume resistivity as high as 2×10⁻⁵ Ω·cm. The circuit pattern had no break and no other defects. However, the observation of the cross section of the Ni film 2 forming the conductor circuit 2a revealed that the density was low. The surface roughness was measured by using an optical interferometer made by ZYGO Co. The result showed that the center line average roughness Ra was as large as close to 2.0 μm, revealing that the surface was far from smooth.

What is claimed is:

1. A paste for electroless plating, comprising:
(a) a minute catalytic powder at least the surface of which is formed by one member selected from the group consisting of:
(a1) a catalytic metal having a catalytic function as an underlying material for electroless plating (hereinafter referred to as the catalytic metal (1)); and
(a2) a metal capable of substituting for the catalytic metal (1) when brought into contact with a solution containing the ion of the catalytic metal (1) (hereinafter referred to as the metal (2)); and
(b) a vehicle in which the catalytic powder is dispersed.

2. A paste for electroless plating as defined by claim 1, wherein the catalytic metal (1) is at least one element selected from the group consisting of Pd, Ag, Au, and Pt.

3. A paste for electroless plating as defined by claim 1, wherein the metal (2) is at least one element selected from the group consisting of Sn and Zn.

4. A paste for electroless plating as defined by claim 1, wherein:
(a) the catalytic powder has a nucleus made of one member selected from the group consisting of metal, synthetic resin, and ceramic; and
(b) the surface of the nucleus is coated with one member selected from the group consisting of the catalytic metal (1) and the metal (2).

5. A paste for electroless plating as defined by claim 4, wherein the nucleus of the catalytic powder is formed by a metallic powder having a structure in which a multitude of minute metallic particles are linked so as to form a chain.

6. A paste for electroless plating as defined by claim 1, the paste further comprising a metallic powder having a structure in which a multitude of minute metallic particles are linked so as to form a chain;
the metallic powder being dispersed in the vehicle to function as a conductive component.

7. A method of producing a metallic structured body, the method comprising the steps of:
(a) preparing a paste for electroless plating that comprises:
(a1) a minute catalytic powder at least the surface of which is formed by one member selected from the group consisting of the catalytic metal (1) and the metal (2); and
(a2) a vehicle in which the catalytic powder is dispersed;
(b) preparing a precursor of the metallic structured body, the precursor having a three-dimensional structure;
(c) applying the paste onto the surface of the precursor to form an underlying film; and
(d) growing a metallic film on the surface of the underlying film through electroless plating by exploiting the catalytic function of the catalytic powder exposed on the surface of the underlying film.

8. A method of producing a metallic structured body as defined by claim 7, wherein the surface of the catalytic powder is formed by the metal (2);
the method further comprising the step of bringing the metal (2) of the catalytic powder exposed on the surface of the underlying film into contact with a solution containing the ion of the catalytic metal (1) to partially replace the metal (2) with the catalytic metal (1) so that the catalytic powder can obtain a catalytic function.

9. A method of producing a metallic structured body as defined by claim 7, the method further comprising the step of further growing the metallic film by electroplating using as the electrode the metallic film grown through the electroless plating.

10. A method of producing a metallic structured body as defined by claim 7, the method further comprising the step of removing the precursor and the vehicle in the underlying film.

11. A method of producing a micrometallic component, the method comprising the steps of:
(a) preparing a paste for electroless plating that comprises:
(a1) a minute catalytic powder at least the surface of which is formed by one member selected from the group consisting of the catalytic metal (1) and the metal (2); and
(a2) a vehicle in which the catalytic powder is dispersed;
(b) preparing a substrate;
(c) preparing a mold form provided with a patterned through hole corresponding with the shape of the micrometallic component to be produced;
(d) applying the paste onto the substrate;
(e) overlaying the mold form on the applied paste;
(f) solidifying the paste while maintaining the overlaying condition to form an underlying film and to securely bond the mold form to the substrate at the same time so that a mold can be produced; and
(g) selectively growing a metallic film corresponding with the shape of the patterned through hole on the surface of the underlying film exposed in the patterned through hole of the mold by electroless plating utilizing the catalytic function of the catalytic powder exposed on the surface of the underlying film.

12. A method of producing a micrometallic component as defined by claim 11, wherein the surface of the catalytic powder is formed by the metal (2);
the method further comprising the step of bringing the metal (2) of the catalytic powder exposed on the surface of the underlying film into contact with a solution containing the ion of the catalytic metal (1) to partially replace the metal (2) with the catalytic metal (1) so that the catalytic powder can obtain a catalytic function.

13. A method of producing a micrometallic component as defined by claim 11, the method further comprising the step of further growing the metallic film by electroplating using as the electrode the metallic film grown through the electroless plating.

14. A method of producing a micrometallic component as defined by claim 11, the method further comprising the step of removing the mold form, the underlying film, and the substrate.

15. A method of producing a micrometallic component, the method comprising the steps of:
(a) preparing a paste for electroless plating that comprises:
(a1) a minute catalytic powder at least the surface of which is formed by one member selected from the group consisting of the catalytic metal (1) and the metal (2); and
(a2) a vehicle in which the catalytic powder is dispersed;
(b) preparing a substrate;
(c) on the substrate, forming by using the paste the pattern of an underlying film corresponding with the shape of the micrometallic component to be produced; and
(d) selectively growing a metallic film corresponding with the shape of the underlying film on the surface of the underlying film on the substrate by electroless plating utilizing the catalytic function of the catalytic powder exposed on the surface of the underlying film.

16. A method of producing a micrometallic component as defined by claim 15, wherein the surface of the catalytic powder is formed by the metal (2);
the method further comprising the step of bringing the metal (2) of the catalytic powder exposed on the surface of the underlying film into contact with a solution containing the ion of the catalytic metal (1) to partially replace the metal (2) with the catalytic metal (1) so that the catalytic powder can obtain a catalytic function.

17. A method of producing a micrometallic component as defined by claim 15, the method further comprising the step of further growing the metallic film by electroplating using as the electrode the metallic film grown through the electroless plating.

18. A method of producing a micrometallic component as defined by claim 15, the method further comprising the step of removing the underlying film and the substrate.

19. A method of producing a conductor circuit, the method comprising the steps of:
(a) preparing a paste for electroless plating that comprises:
(a1) a minute catalytic powder at least the surface of which is formed by one member selected from the group consisting of the catalytic metal (1) and the metal (2); and
(a2) a vehicle in which the catalytic powder is dispersed;
(b) preparing a substrate;
(c) on the substrate, forming by using the paste the pattern of an underlying film corresponding with the shape of the conductor circuit to be produced; and
(d) selectively growing a metallic film corresponding with the shape of the underlying film on the surface of the underlying film on the substrate by electroless plating utilizing the catalytic function of the catalytic powder exposed on the surface of the underlying film.

20. A method of producing a conductor circuit as defined by claim 19, wherein the surface of the catalytic powder is formed by the metal (2);
the method further comprising the step of bringing the metal (2) of the catalytic powder exposed on the surface of the underlying film into contact with a solution containing the ion of the catalytic metal (1) to partially replace the metal (2) with the catalytic metal (1) so that the catalytic powder can obtain a catalytic function.

21. A method of producing a conductor circuit as defined by claim 19, the method further comprising the step of further growing the metallic film by electroplating using as the electrode the metallic film grown through the electroless plating.
